(19) United States
(12) Patent Application Publication
(10) Pub. No.: US 2015/0293929 A1
(43) Pub. Date: Oct. 15, 2015

(54) METHOD AND APPARATUS FOR PROCESSING WEBPAGE IN TERMINAL DEVICE BY USING CLOUD SERVER

(71) Applicant: SAMSUNG ELECTRONICS CO., LTD., Suwon-si (CN)

(72) Inventor: Eun Namgung, Hwaseong-si (KR)

(73) Assignee: SAMSUNG ELECTRONICS CO., LTD., Suwon-si (KR)

(21) Appl. No.: 14/439,751

(22) PCT Filed: Oct. 30, 2013
(86) PCT No.: PCT/KR2013/009698

§ 371 Date: Apr. 30, 2015

(30) Foreign Application Priority Data
Oct. 30, 2012 (KR) 10-2012-0121518

(51) Int. Cl. G06F 17/30; G06F 9/54; G06F 17/22

(52) U.S. Cl. CPC G06F 17/3089; G06F 17/2247; G06F 9/542

(57) ABSTRACT

Provided is a method of processing a webpage, the method involving transmitting address information of a webpage and display information of a terminal device to a cloud server; receiving information on a layout of the webpage and tiles of the webpage from the cloud server in response to the transmission; and displaying one or more of the tiles according to the information, wherein the tiles of the webpage are obtained by dividing the webpage into the plurality of images based on the display information of the terminal device.

### CROSS REFERENCE TO RELATED APPLICATIONS

This application is a National Stage of International Application No. PCT/KR2013/009698, filed Oct. 30, 2013, and claims priority from Korean Patent Application No. 10-2012-0121518 filed Oct. 30, 2012, the contents of which are incorporated herein by reference in their entireties.

### BACKGROUND

1. Field

Methods and apparatuses consistent with exemplary embodiments relates to a method and apparatus for a terminal device to output a webpage processed in a cloud server.

2. Description of Related Art

When a terminal device receives a request to output a webpage, the terminal device downloads required data, such as texts or images from a Uniform/Universal resource locator (URL) of the webpage in a web browser of the terminal device, configures an appropriate layout by interpreting a Hypertext Mark-up Language (HTML) or a java script that configures the webpage, and then outputs the webpage on a display screen of the terminal device according to the configured layout.

However, when complicated web contents are included in the webpage, it requires significant memory and central processing unit (CPU) resources for the terminal device to download data related to the webpage and configure the layout required to interpret and process elements of the webpage. Accordingly, a low-spec terminal device frequently has a problem in outputting such a high-tech grade webpage.

In addition, because many terminal devices use different layout schemes in consideration of their capacities, a webpage may be output differently on the terminal devices.

Accordingly, there is a demand for a technology that enables even a low-spec terminal to output a webpage including high-tech contents and that allows a webpage to be output on different terminal devices in the same fashion.

### SUMMARY

According to an aspect of an exemplary embodiment, there is provided a method for a terminal device to process a webpage, the method comprising: transmitting address information of a webpage and display information of a terminal device to a cloud server; receiving layout information indicating a layout of the webpage and tiles of the webpage from the cloud server in response to the transmitting; and displaying one or more of the tiles according to the layout information, wherein the tiles of the webpage are obtained by dividing the webpage into a plurality of images based on the display information of the terminal device.

The method may further include operations of receiving a user input to change a view port of the webpage; displaying a tile corresponding to a position and a size of the changed view port among the received tiles of the webpage; transmitting information on the position and the size of the changed view port to the cloud server; and receiving at least one tile of the webpage from the cloud server, and wherein the at least one tile is determined by the cloud server based on the display information and the changed view port.

The method may further include operations of receiving a user input on the webpage; transmitting coordinate information of the user input on the webpage to the cloud server; receiving a result of an event triggered by the input from the cloud server; and outputting the result of the event.

The operation of displaying the tile may include operations of, receiving data output information regarding non-image data included in a part of the webpage corresponding to the one or more of the tiles from the cloud server; receiving the non-image data using address information of the non-image data included in the data output information; processing the non-image data using the data output information; combining the processed non-image data with the one or more of the tiles; and outputting the one or more of the tiles combined with the non-image data

According to another aspect of an exemplary embodiment, there is provided a method for a cloud server to process a webpage, the method comprising: receiving address information of a webpage and display information of a terminal device from the terminal device; configuring a layout of the webpage corresponding to the address information based on the display information of the terminal device; generating tiles of the webpage by dividing the webpage into a plurality of images according to the layout; and transmitting one or more of the tiles and information on the layout to the terminal device.

The method may further include operations of receiving information on a position and a size of a changed view port from the terminal device; generating new tiles by dividing the webpage into a plurality of images based on the information on the position and the size of the changed view port, according to the layout; and transmitting one or more of the new tiles to the terminal device.

The method may further include operations of collecting event information on events that are triggered from the webpage by a user input on the terminal device; receiving input information regarding a user input received on the webpage from the terminal device; determining event information corresponding to the received input information; performing an event based on the determined event information; and transmitting a response message comprising a performance result of the event to the terminal device, wherein the received input information comprises coordinate information of the input on the webpage.

The operation of generating may include operations of, transmitting output information related to non-image data included in an area of the webpage corresponding to the tiles to the terminal device, wherein the output information includes at least one of information about a method of processing the non-image data, information on a location where the non-image data is to be received, and information on a position where the non-image data is visualized in the tiles.

The method may further include operations of determining that another set of layout information and tiles of the webpage generated based on display information identical to the display information of the terminal device are stored; generating new tiles by dividing the webpage into a plurality of images using the stored layout information and the stored tiles when the layout information and the tiles of the webpage are stored; and transmitting the new tiles to the terminal device.

### BRIEF DESCRIPTION OF THE FIGURES

The above and other aspects will become more apparent by describing in detail exemplary embodiments thereof with reference to the attached drawings in which:

FIG. 1 is a block diagram illustrating a system for processing a webpage of a terminal device using a cloud server according to an exemplary embodiment;

FIG. 2(a) is a block diagram illustrating a structure of a cloud server that provides a webpage to a terminal device by processing the webpage, according to an exemplary embodiment;

FIG. 2(b) is a block diagram illustrating a structure of the cloud server that provides a webpage to a terminal device by processing the webpage, according to an exemplary embodiment;

FIG. 3(a) is a block diagram illustrating a structure of the terminal device that processes a webpage using the cloud server of FIG. 2(a) and then outputs the webpage, according to an exemplary embodiment;

FIG. 3(b) is a block diagram illustrating a structure of the terminal device that processes a webpage using the cloud server of FIG. 2(b) and outputs the webpage, according to an exemplary embodiment;

FIG. 4 is a flowchart of a method of processing, by the terminal device, a webpage using the cloud server, according to exemplary embodiment;

FIG. 5 is a flowchart of a method of processing, by the cloud server, a webpage in response to a request from the terminal device, according to an exemplary embodiment;

FIG. 6 illustrates exemplary embodiments of a method of configuring a layout and generating tiles of a webpage;

FIG. 7 is a block diagram illustrating a structure of a cloud server that provides a webpage to a terminal device after processing the webpage when a view port changes, according to an exemplary embodiment;

FIG. 8 is a block diagram illustrating a structure of the terminal device that outputs a webpage when a view port changes, according to an exemplary embodiment;

FIG. 9 is a flowchart illustrating a method for a cloud server to process a webpage when a view port changes, according to an exemplary embodiment;

FIG. 10 is a flowchart illustrating a method for a terminal device to process a webpage as a view port changes, according to an exemplary embodiment;

FIG. 11 is a signal flow graph illustrating a communication between a terminal device and a cloud server to process a webpage when a view port changes, according to an exemplary embodiment;

FIG. 12 illustrates an exemplary embodiment in which a terminal device processes a webpage using a cloud server when a view port changes;

FIG. 13 is a block diagram illustrating a structure of a cloud server according to an exemplary embodiment;

FIG. 14 is a block diagram illustrating a structure of the terminal device according to an exemplary embodiment;

FIG. 15 is a flowchart illustrating a method for a cloud server to process a webpage when an input is performed on the webpage that is displayed on the terminal device, according to an exemplary embodiment;

FIG. 16 is a flowchart illustrating a method for a terminal device to process a webpage using a cloud server when an input is performed on the webpage to trigger an event, according to an exemplary embodiment;

FIG. 17 is a block diagram illustrating a structure of a cloud server that processes a webpage including non-image data according to an exemplary embodiment;

FIG. 18 is a block diagram illustrating a structure of the terminal device that outputs a webpage including non-image data according to an exemplary embodiment;

FIG. 19 is a flowchart illustrating a method for a cloud server to process a webpage including non-image data according to an exemplary embodiment; and

FIG. 20 is a flowchart illustrating a method for a terminal device to process a webpage including non-image data according to an exemplary embodiment.

### DETAILED DESCRIPTION OF EXEMPLARY EMBODIMENTS

Hereinafter, exemplary embodiments will be described in detail with reference to the attached drawings. In the following description, well-known functions or constructions are not described in detail since they would obscure the exemplary embodiments with unnecessary detail.

Same reference numerals in the drawings denote the same element throughout the specification.

Also, terms or words used in the following description should not be construed as being limited to common or general meanings but should be construed as being used for the purpose of describing particular exemplary embodiments only and is not intended to be limiting of exemplary embodiments. The exemplary embodiments may, however, be embodied in many different forms and should not be construed as being limited to the exemplary embodiments set forth herein; rather, the disclosure is provided to explain the exemplary embodiments to those skilled in the art.

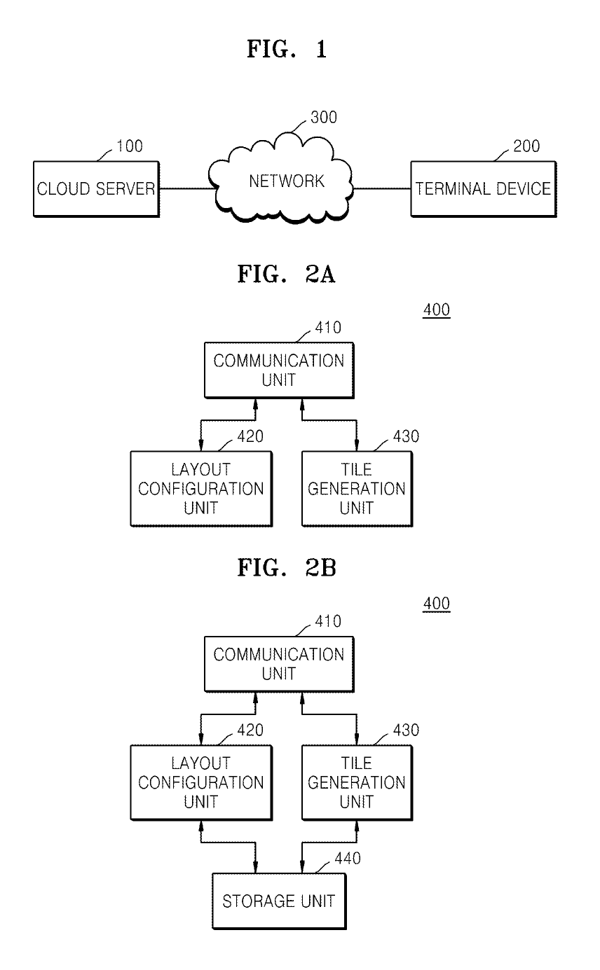

FIG. 1 is a block diagram illustrating a system for processing a webpage of a terminal device using a cloud server according to an exemplary embodiment.

Referring to FIG. 1, the system may include a cloud server 100, a terminal device 200, and a network 300.

The cloud server 100 may configure a layout of a webpage, in consideration of display information of the terminal device 200, generate tiles by dividing the webpage into a plurality of images according to the layout, and provide the tiles to the terminal device 200. The display information of may indicate, but is not limited to, a screen size and/or a resolution of the terminal device 200. The terminal device 200 may receive the webpage in an image form, which is processed by the cloud server 100, from the cloud server 100 and may output the webpage.

The terminal device 200 may be one of various devices used by a user, and may include a personal computer (PC), a notebook computer, a mobile phone, a tablet PC, a navigation terminal, a smart phone, a personal digital assistant (PDA), a smart TV, a portable multimedia player (PMP), and a digital broadcasting receiver.

The network 300 provides a medium for data exchange between the cloud server 100 and the terminal device 200.

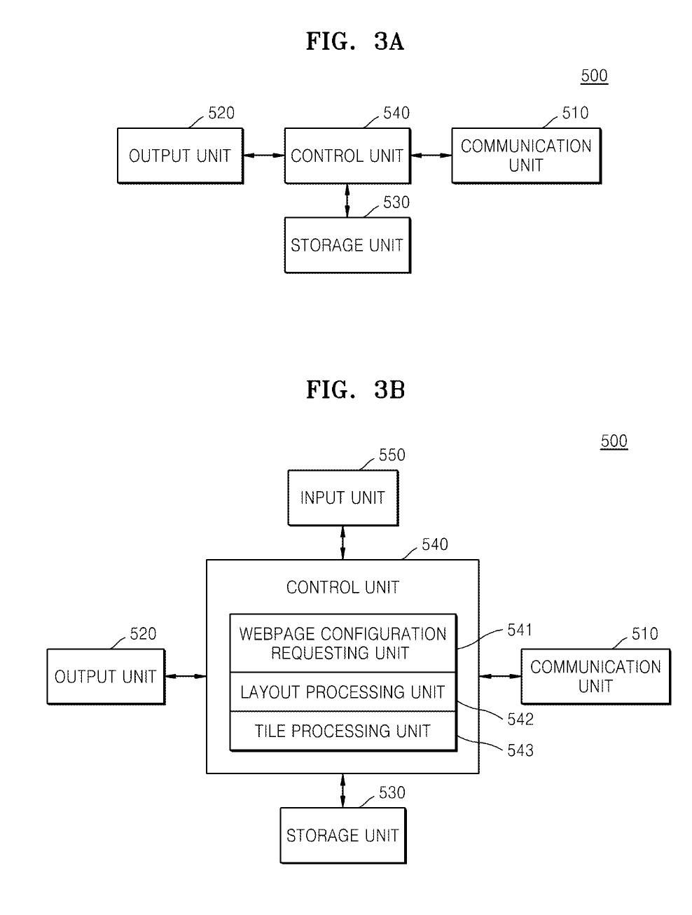

FIG. 2(a) is a block diagram illustrating a structure of a cloud server 400 that provides a webpage to a terminal device 500 of FIG. 3(a) after processing the webpage, according to an exemplary embodiment.

Referring to FIG. 2(a), the cloud server 400 may include a communication unit 410, a layout configuration unit 420, and a tile generation unit 430.

The communication unit 410 exchanges data with a plurality of the terminal devices 500 via a network.

The layout configuration unit 420 configures a layout of a webpage to be applied to the webpage displayed on a terminal device based on layout information of the webpage downloaded using address information and display information of the terminal device. Here, configuring the layout means constructing a Render Tree and a Document Object Model (DOM) Tree. The DOM Tree indicates a structure of the webpage, and the Render Tree indicates how each element of the DOM Tree is displayed and may include information about a style and an array order.

The tile generation unit 430 configures the webpage according to the layout configured by the layout configuration unit 420, divides the webpage based on a display size of the terminal device 500, into a plurality of images, and thus generates tiles.

The webpage is divided into one or more webpage areas according to the layout, and a display screen of the terminal device is correspondingly divided into one or more screen areas so that each screen area may display one webpage area Based on a size of each display area and a size of its corresponding webpage area, one or more tiles may be generated per webpage area. The tile generation unit 430 may divide the entire webpage or some parts of the webpage into the plurality of images to generate the tiles. A size of the tiles may be determined based on the display size of the terminal device 500 according to the layout configured by the layout configuration unit 420.

The generation of the tiles by the tile generation unit 430 will be described in more detail with reference to FIG. 6.

FIG. 2(b) is a block diagram illustrating another structure of the cloud server 400 that provides a webpage to a terminal device 500 (refer to FIG. 3(b)) by processing the webpage, according to another exemplary embodiment.

Referring to FIG. 2(b), the cloud server 400 may include the communication unit 410, the layout configuration unit 420, the tile generation unit 430, and a storage unit 440. The communication unit 410, the layout configuration unit 420, and the tile generation unit 430 of FIG. 2(b) may have features similar to the communication unit 410, the layout configuration unit 420, and the tile generation unit 430 of FIG. 2(a), respectively, and thus redundant descriptions thereof are omitted.

The storage unit 440 may store layout information of the webpage configured by the layout configuration unit 420 and the tiles of the webpage generated by the tile generation unit 430. The storage unit 440 may include all types of storage medium, such as Random Access Memory (RAM), Read Only Memory (ROM), Hard Disk Drive (HDD), flash memory, CD-ROM, Digital Versatile Disc (DVD), or the like.

FIG. 3(a) is a block diagram illustrating a structure of the terminal device 500 that processes a webpage using the cloud server 400 of FIG. 2(a) and then outputs the webpage, according to an exemplary embodiment.

Referring to FIG. 3(a), the terminal device 500 of FIG. 3(a) may include a communication unit 510, an output unit 520, a storage unit 530, and a control unit 540.

The communication unit 510 exchanges data with the cloud server 400 via a network.

The output unit 520 displays tiles of the webpage received from the cloud server 400, according to a layout of the webpage. The tiles of the webpage in an image form may be displayed in corresponding screen areas of the display screen according to the layout that is configured by the cloud server 400.

The storage unit 530 stores the tiles of the webpage received from the cloud server 400, and layout information of the webpage which is configured by the cloud server 400. The storage unit 530 may include all types of storage medium, such as RAM, ROM, HDD, flash memory, CD-ROM, DVD, or the like.

While the storage unit 530 stores information about the terminal device 500, the tiles of the webpage, and the layout information, if the terminal device 500 or another terminal device that has display information the same as the terminal device 500 requests the terminal device 500 to process a webpage whose layout and tiles were previously generated and stored, the terminal device 500 may generate tiles of the webpage using the layout information and the tiles prestored in the storage unit 530 and provide the generated tiles to the other terminal device.

The control unit 540 controls overall operations of the terminal device 500. Specifically, the control unit 540 builds a basic platform environment of the terminal device 500 based on an operating system stored in the storage unit 530 and provides an arbitrary function by executing an application program according to user selection. In more detail, the control unit 540 transmits address information of a webpage to be output and display information of the terminal device 500 to the cloud server 400, and displays tiles of the webpage based on the layout information received in response to the transmission. Here, when the display information of the terminal device 500 is already stored in the cloud server 400, the control unit 540 may transmit identification (ID) information of the terminal device 500 instead of the display information of the terminal device 500. Also, the control unit 540 may divide a display screen the terminal device 500 into a plurality of screen areas according to the layout information of the webpage which is configured by the cloud server 400, and arrange the tiles, which are received from the cloud server 400, to be output to corresponding screen areas.

The output of the tiles by the control unit 540 will be described in more detail with reference to FIG. 6.

FIG. 3(b) is a block diagram illustrating a structure of the terminal device 500 that processes a webpage using the cloud server 400 of FIG. 2(b) and then outputs the webpage, according to another exemplary embodiment.

Referring to FIG. 3(b), the terminal device 500 of FIG. 3(b) may include the communication unit 510, the output unit 520, the storage unit 530, the control unit 540, and an input unit 550. The communication unit 510, the output unit 520, the storage unit 530, and the control unit 540 of FIG. 3(b) may have features similar to the communication unit 510, the output unit 520, the storage unit 530, and the control unit 540 of FIG. 3(a), respectively, and thus redundant descriptions thereof are omitted.

The control unit 540 may include a webpage configuration requesting unit 541, a layout processing unit 542, and a tile processing unit 543.

The webpage configuration requesting unit 541 transmits display information of the terminal device 500 and address information of a webpage to the cloud server 400, and then requests the cloud server 400 to process and transmit the webpage. Here, when the display information of the terminal device 500 is already stored in the cloud server 400, the webpage configuration requesting unit 541 may transmit ID information of the terminal device 500 instead of its display information.

The layout processing unit 542 divides a display screen into a plurality of screen areas and arranges the tiles to be displayed in the corresponding screen areas according to the layout information of the webpage which is configured by the cloud server 400.

The tile processing unit 543 determines one or more tiles to be displayed from among a plurality of tiles received from the cloud server 400, according to predetermined setting information. Here, a tile is one of a plurality of images obtained by dividing a webpage. A display screen may be divided into multiple areas and different number of tiles may be created to be displayed in each area. One or more tiles to be displayed in an area for which a plurality of tiles were generated may be determined by the tile processing unit 543. While the determined tile is displayed in the corresponding area, when displaying area of the webpage, i.e., a view port, is changed in response to a control input from a user, one or more tiles that correspond to a location of a changed view port may be displayed.

The webpage configuration requesting unit 541, the layout processing unit 542, and the tile processing unit 543 may be implemented by software, hardware, or a combination of software and hardware. For example, the webpage configuration requesting unit 541, the layout processing unit 542, and the tile processing unit 543 may be stored as programs in the storage unit 530 and then may be implemented when the control unit 540 executes the programs.

The input unit 550 may generate a control signal for controlling or operating the terminal device 500 in response to an external input, e.g., user manipulation, and may be implemented in various forms. A webpage output request by a user or the change of the view port may be received by the terminal device 500 via the input unit 550.

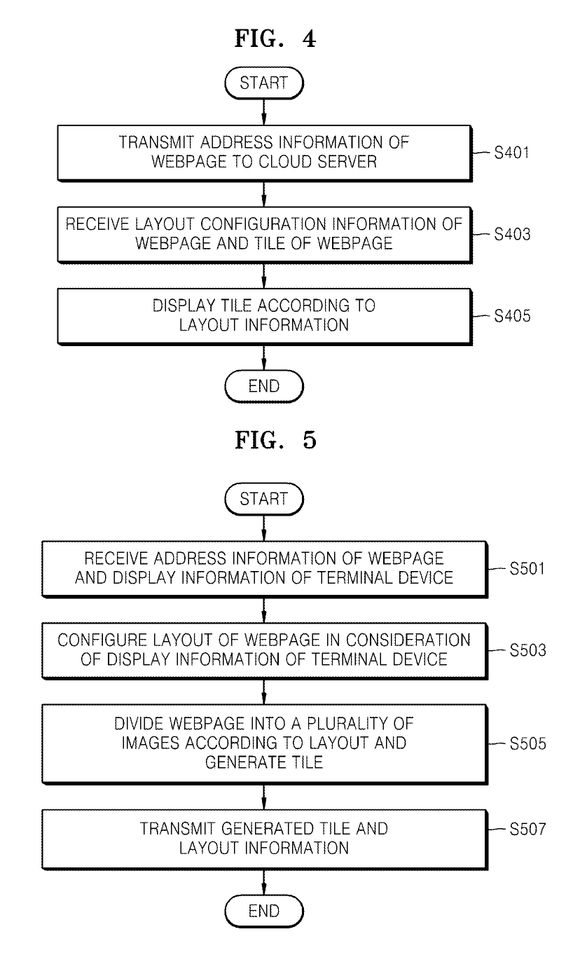

FIG. 4 is a flowchart of a method of processing, by the terminal device 500, a webpage using the cloud server 400 of FIG. 2, according to an exemplary embodiment.

Referring to FIG. 4, the terminal device 500 transmits address information of a webpage to be output and display information of the terminal device 500 to the cloud server 400, requesting the cloud server 400 to process and transmit the webpage (operation S401). Here, when the display information of the terminal device 500 is already stored in the cloud server 400, the terminal device 500 may transmit ID information of the terminal device 500 instead of its display information.

In response to the request to process the webpage, the terminal device 500 receives layout configuration information of the webpage and a tile from the cloud server 400 (operation S403). The terminal device 500 may display the tile according to the layout configuration information of the webpage received from the cloud server 400 (operation S405).

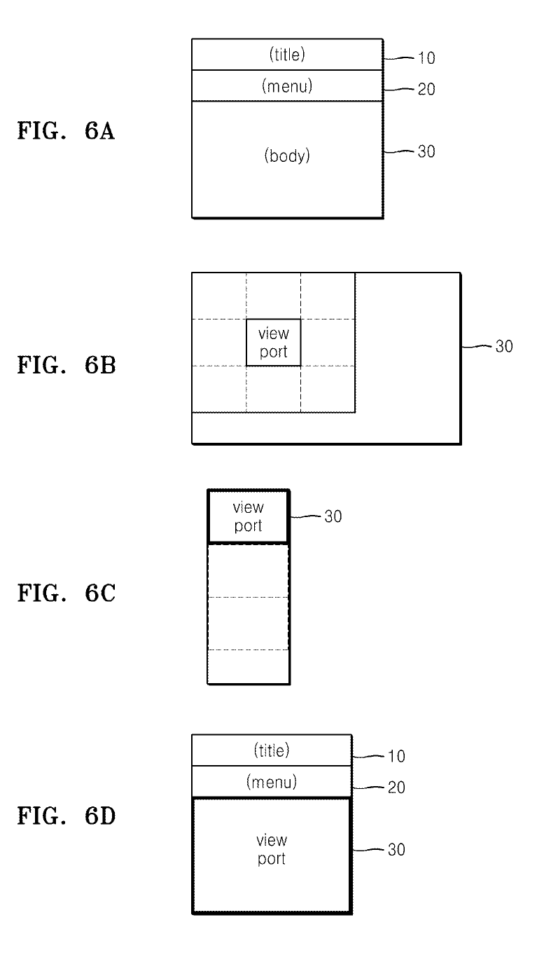

FIG. 5 is a flowchart of a method of processing, by the cloud server 400, a webpage in response to a request from the terminal device 500, according to an exemplary embodiment.

The cloud server 400 receives address information of the webpage to be output and display information of the terminal device 500 from the terminal device 500 (operation S501). The cloud server 400 may download data of the webpage using the address information of the webpage according to the request from the terminal device 500, and may configure a layout of the webpage in consideration of the display information of the terminal device 500 (operation S503). Here, the layout of the webpage may vary according to the display information of the terminal device 500. Because a layout that is comfortable to eyes of a user may vary according to a size of a display of the terminal device 500, the display information of the terminal device 500 may be considered in configuration of the layout. For example, assuming the same webpage, configuration of a layout for a PC monitor may be different from one for a mobile phone having smaller display.

The cloud server 400 may configure the layout of the webpage, divide the webpage into a plurality of images according to the layout to generate tiles (operation S505). Here, based on a size of each screen area of a display screen and a size of a webpage area to be displayed in corresponding screen area, different numbers of tiles may be generated per each webpage area. That is, the tiles of the webpage may be generated independently for each of the webpage areas that are divided according to the layout.

The cloud server 400 may generate the tiles of the webpage for each of the webpage areas that are divided according to the layout, and may transmit the generated tiles and the layout information to the terminal device 500 (operation S507).

FIG. 6 illustrates exemplary embodiments of a method of configuring a layout and generating tiles of a webpage.

FIG. 6(a) illustrates the example of a configured layout of a webpage. Assuming the terminal device 500 has a vertically long display, the layout may be configured to divide the display screen into three webpage areas, a title 10, a menu 20, and a body 30 and array them in a sequential order lengthwise, as shown in FIG. 6(a).

For user convenience, it is desirable that a screen area for the title 10 or the menu 20 displays the entire contents of its corresponding webpage area, so one tile may be generated for the webpage area containing the title 10 or the menu 20.

On the other hand, assuming some contents having a large visual size are contained in the body 30 so scrolling is required within its screen area to navigate the contents, a plurality of tiles may be generated for the webpage area containing the body 30.

FIGS. 6(a) and 6(b) illustrate the examples in which the tiles are generated in the area of the webpage which corresponds to the body 30.

To improve readability, if the webpage of the body 30 is considerably larger than a size of the display of the terminal device 500, a total of 9 tiles may be generated as shown in FIG. 6(b).

Also, to improve readability, if a horizontal length of the webpage of the body 30 is equal to a horizontal length of the display of the terminal device 500, a plurality of tiles may be generated to be arrayed in a vertical direction as shown in FIG. 6(c).

FIG. 6(b) illustrates the example in which a tile that is positioned in a view port of the body 30 is displayed, and the tile is one of a plurality of tiles that are generated by dividing the webpage of the body 30 into a plurality of images. The view port means a part of the webpage which is to be displayed on the display screen of the terminal device 500. When the webpage is first displayed, the view port may be a position that is designated on the webpage according to a predetermined setting.

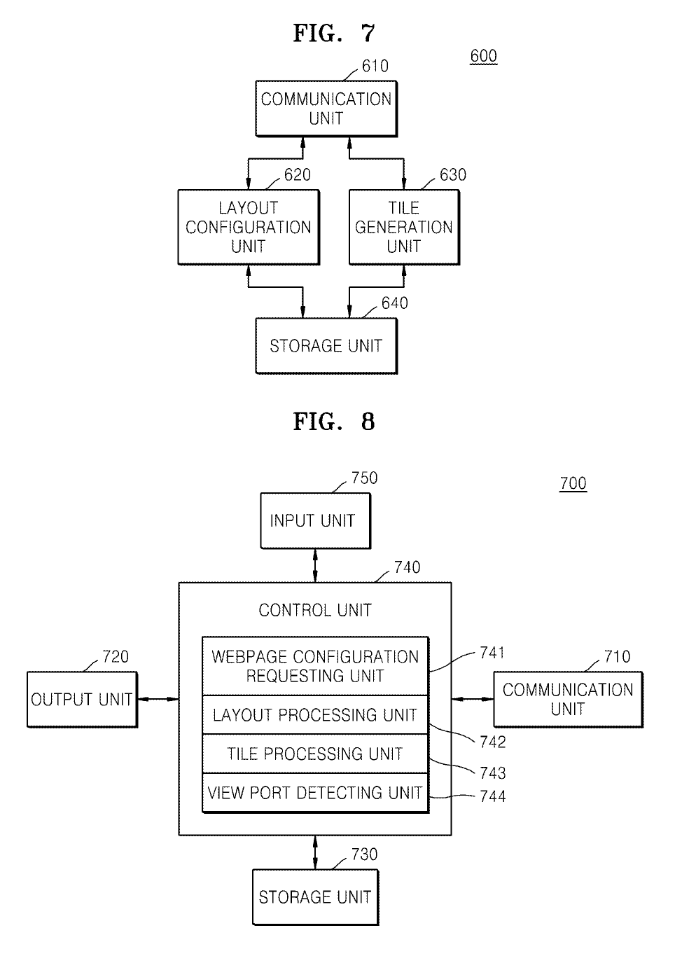

FIG. 7 is a block diagram illustrating a structure of a cloud server 600 that provides a webpage to a terminal device 700 by processing the webpage based on changed view port information, according to an exemplary embodiment.

Referring to FIG. 7, the cloud server 600 may include a communication unit 610, a layout configuration unit 620, a tile generation unit 630, and a storage unit 640. The communication unit 610, the layout configuration unit 620, the tile generation unit 630, and the storage unit 640 may have features similar to the communication unit 410, the layout configuration unit 420, the tile generation unit 430, and the storage unit 440 of FIG. 2, respectively, and thus redundant descriptions thereof are omitted.

The tile generation unit 630 configures the webpage according to a layout generated by the layout configuration unit 620, and generates tiles by dividing the webpage into a plurality of images based on a size of a display of the terminal device 700. When the cloud server 600 receives the changed view port information of the webpage from the terminal device 700, the tile generation unit 630 again generates tiles by dividing the webpage into a plurality of images according to the changed view port information.

A view port may be changed in response to a user input. For example, when a user scrolls the webpage, a position of the view port to be displayed may be changed. Also, when the user zooms in or out on a screen, a size of the view port to be displayed may be changed.

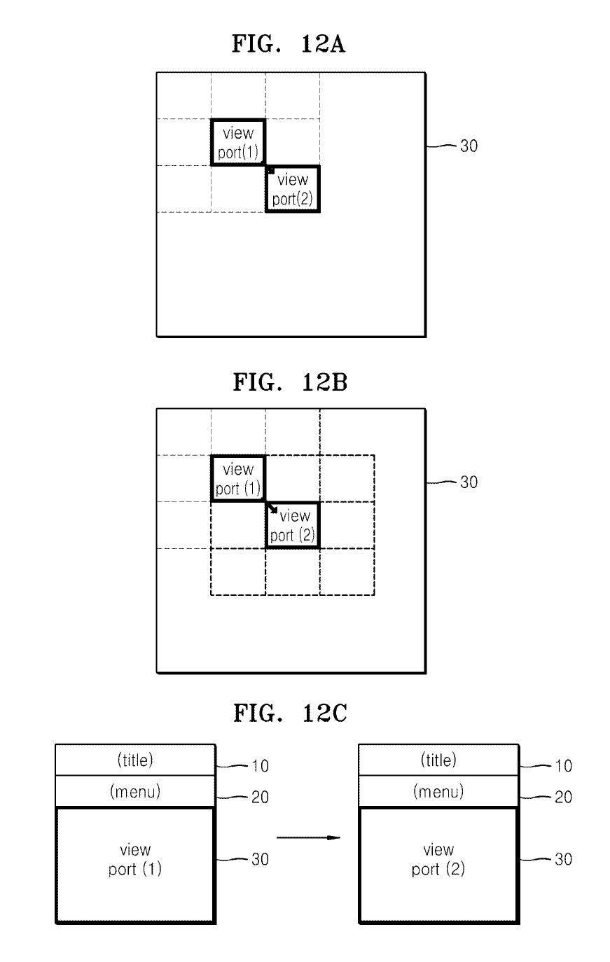

The renewed generation of the tiles by the tile generation unit 630, in a case of a change in the view port, will be described in more detail with reference to FIG. 12.

FIG. 8 is a block diagram illustrating a structure of the terminal device 700 that processes and outputs a webpage according to changed view port information using the cloud server 600, according to another exemplary embodiment.

Referring to FIG. 8, the terminal device 700 may include a communication unit 710, an output unit 720, a storage unit 730, a control unit 740, and an input unit 750. The communication unit 710, the output unit 720, the storage unit 730, the control unit 740, and the input unit 750 of FIG. 8 may include features similar to the communication unit 510, the output unit 520, the storage unit 530, the control unit 540, and the input unit 550 of FIG. 3, respectively, and thus redundant descriptions thereof are omitted.

The control unit 740 may include a webpage configuration requesting unit 741, a layout processing unit 742, a tile processing unit 743, and a view port detecting unit 744.

The webpage configuration requesting unit 741 transmits display information of the terminal device 500 and address information of the webpage to the cloud server 600 and then requests the cloud server 600 to process and transmit the webpage. When a view port of the webpage is changed, the webpage configuration requesting unit 741 may transmit changed view port information to the cloud server 600 and request the cloud server 600 to transmit one or more tiles that are generated based on the changed view port.

When the view port of the webpage that is currently displayed on a display of the terminal device 700 is changed, the view port detecting unit 744 may detect the change of the view port and thus may generate position information and size information about the changed view port.

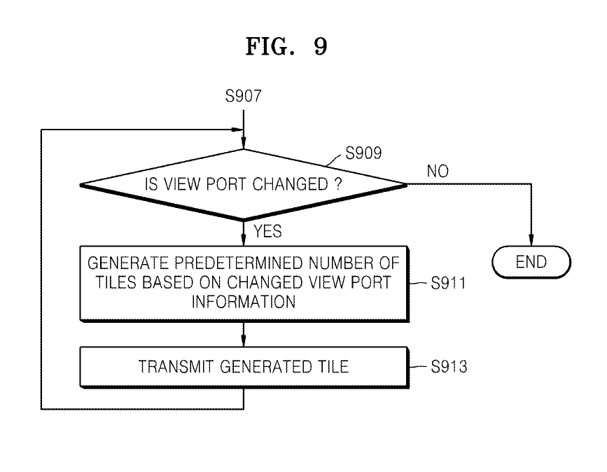

FIG. 9 is a flowchart of a method of processing, by the cloud server 600, a webpage according to changed view port information, in response to a request from the terminal device 500, according to an exemplary embodiment.

Operation 5907 of the flowchart in FIG. 9 may correspond to operation 5507 of the flowchart in FIG. 5. Thus, the flowchart of FIG. 9 may include operations 5501, 5503, and S505 before operation 5907.

Referring to FIG. 9, when the cloud server 600 receives the changed view port information from the terminal device 700 (operation S909), the cloud server 600 may generate tiles by dividing the webpage into a plurality of images based on the changed view port information (operation S911), and may transmit the tiles to the terminal device 700 (operation S913).

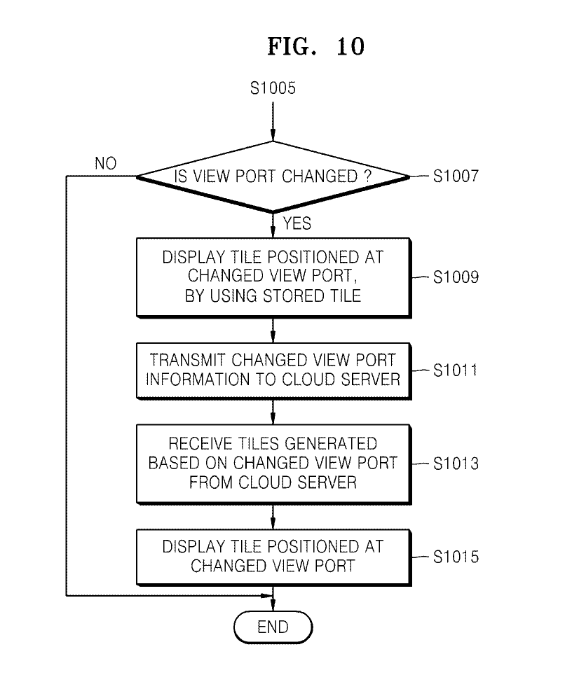

FIG. 10 is a flowchart of a method of processing, by the terminal device 700, a webpage using the cloud server 600 based on changed view port information, according to an exemplary embodiment.

Operation S1005 of the flowchart in FIG. 10 may correspond to operation S405 of the flowchart in FIG. 4. Thus, the flowchart of FIG. 10 may include operations S401 and S403 before operation S1005.

Referring to FIG. 10, when a view port of the webpage displayed on a display of the terminal device 700 is changed (operation S1007), it is determined whether a tile positioned at the changed view port is already stored (operation S1008). The terminal device 700 may display the tile without connecting to the cloud server 600 if the tile was previously received from the cloud server 600 and is still stored in the terminal device 700 (operation S1009).

However, if a tile corresponding the changed view port, e.g., when an input moves the view port in the webpage beyond the stored tiles, the terminal device 700 cannot properly display the part of the webpage corresponding to the changed view port using only the stored tiles. In this case, the terminal device 700 transmits position information and size information about the changed view port on the webpage to the cloud server 600 (operation S1011), and in response to the transmission, the terminal device 700 may receive one or more tiles, which are generated based on the changed view port, from the cloud server 600 (operation S1013). The tile, among the received tiles, positioned at the changed view port may be displayed on the terminal device 700 (operation S1015), and the remaining received tiles may be stored in the terminal device 700 and may be displayed later when the view port is changed again.

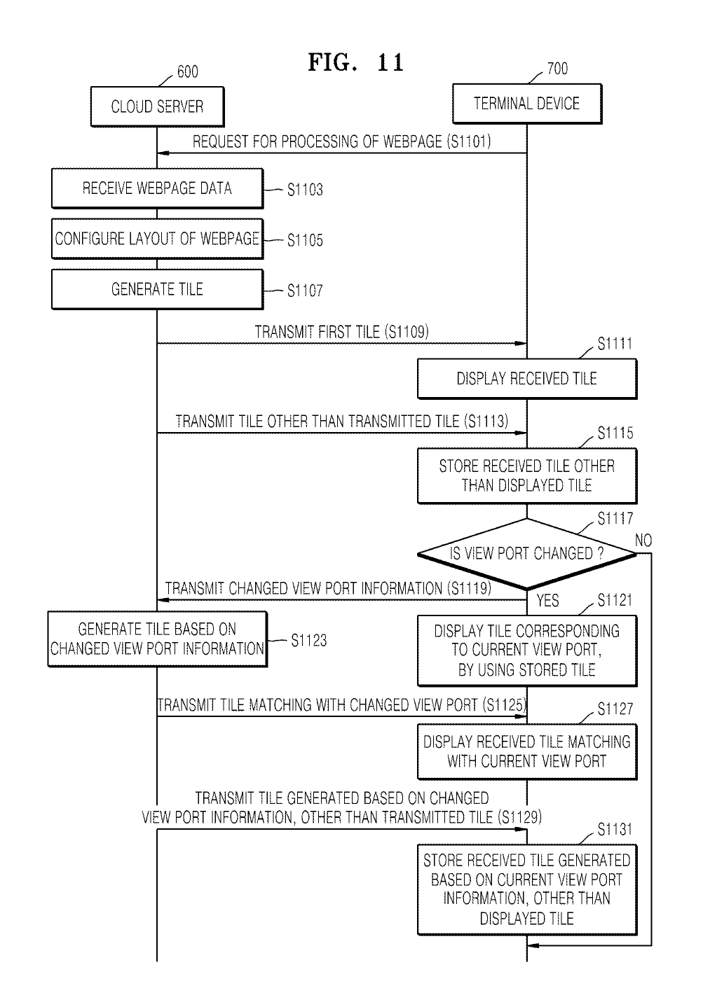

FIG. 11 is a flowchart of a method of processing, by the terminal device 700, a webpage using the cloud server 600 based on changed view port information, according to an exemplary embodiment.

When the terminal device 700 requests the cloud server 600 to process the webpage (operation S1101), the cloud server 600 may download data required to configure the webpage, using address information of the webpage (operation S1103), and configure a layout of the webpage (operation S1105). Also, the cloud server 600 may generate tiles by dividing the webpage into a plurality of images according to the layout (operation S1107).

The cloud server 600 may transmit one or more tiles to the terminal device 700. Here, the cloud server may send a tile to be immediately displayed on the terminal device 700, i.e., a tile covering a current port view, ahead of other tiles. (operation S1109). The terminal device 700 that has received the tile to be immediately displayed may display the tile (operation S1111), receive other tiles (operation S1113) and store the received tiles (operation S1115).

When a view port is changed on the webpage of the terminal device 700 (operation S1117), the terminal device 700 may transmit the changed view port information to the cloud server 600 and request the cloud server 600 to again generate a tile based on the changed view port information (operation S1119).

When the cloud server 600 receives a tile generation request from the terminal device 700, the cloud server 600 may generate a tile based on the changed view port information (operation S1123) and transmit the tile matching the changed view port information ahead of other tiles to the terminal device 700 (operation S1125). Before the terminal device 700 receives the tile, which is generated based on the changed view port information, from the cloud server 600, if one of the tiles that are stored in operation S1115 is positioned at the changed view port, the terminal device 700 may display the tile instead of receiving the tile from the cloud server (operation S1121). Therefore, if a proper tile matching a current view port is already stored in the terminal device 700, operations S1125 and S1127 may be omitted.

The terminal device 700 that has first received the tile matching the changed view port information may display the tile (operation S1127), receive other tiles that are generated based on the changed view port information (operation S1129), and store the tiles (operation S1131).

FIG. 12 illustrates exemplary embodiments in which the terminal device 700 processes a webpage using the cloud server 600 based on changed view port information.

FIG. 12(a) illustrates an exemplary embodiment in which a view port is changed in a body area 30 of a webpage.

FIG. 12(b) illustrates an exemplary embodiment in which new tiles are generated in the cloud server 600 based on a changed view port.

FIG. 12(c) illustrates an exemplary embodiment in which a tile which corresponds to a changed view port is displayed.

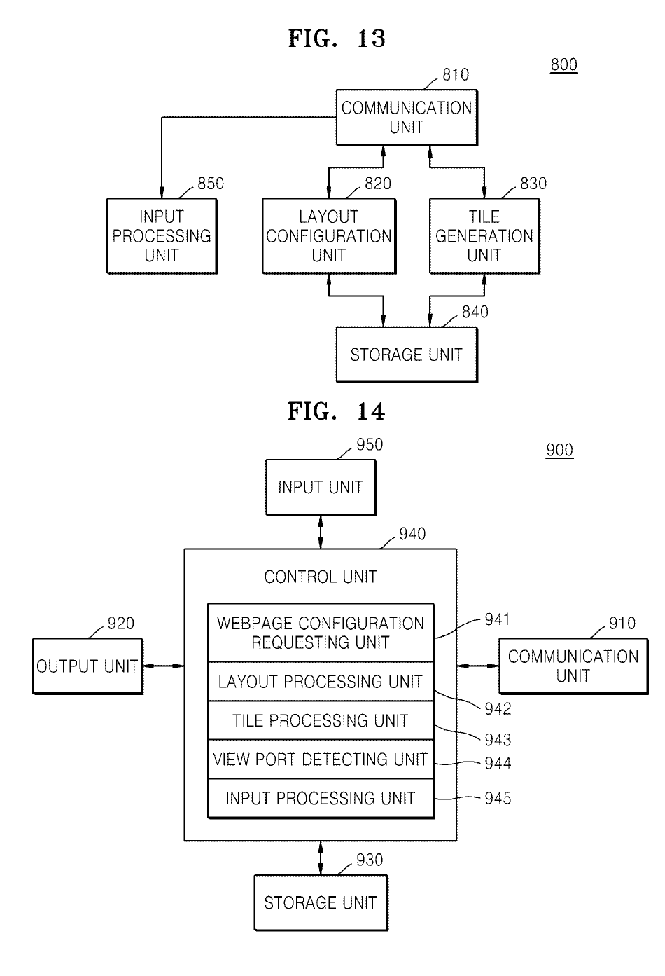

FIG. 13 is a block diagram illustrating a structure of a cloud server 800 that processes a webpage and provides the processed webpage to a terminal device 900 when an input is performed on the webpage, according to an exemplary embodiment.

Referring to FIG. 13, the cloud server 800 may include a communication unit 810, a layout configuration unit 820, a tile generation unit 830, a storage unit 840, and an input processing unit 850. The communication unit 810, the layout configuration unit 820, the tile generation unit 830, and the storage unit 840 may have features similar to the communication unit 410, the layout configuration unit 420, the tile generation unit 430, and the storage unit 440 of FIG. 2, respectively, and thus redundant descriptions thereof are omitted.

When the input processing unit 850 receives input information about an input performed in the terminal device 900, the input processing unit 850 performs an event according to the input by processing the input information and transmits a result of the performance to the terminal device 900.

In a case of a touch input, the cloud server 800 may receive information from the terminal device 900, and the information includes coordinate information about coordinates of a touch input in a view port, view port information, and information about touch types such as a drag, a tab, and the like. Here, the input processing unit 850 detects a position of the touch input on the webpage using the coordinate information and the view port information, and determines if there exists any event to be performed at the detected position with the touch input. For the determination, the input processing unit 850 may previously collect a plurality of pieces of information about events to be possibly performed with an input on the webpage by analyzing the webpage when generating tiles and store the information in the storage unit 840.

When the event to be possibly performed with the touch input indicates movement to a new webpage, the input processing unit 850 may configure a layout of the new webpage using the collected information about events and may transmit a tile, which is generated according to the layout, to the terminal device 900.

FIG. 14 is a block diagram illustrating a structure of the terminal device 900 that processes and outputs a webpage using the cloud server 800 when an input is performed on the webpage, according to an exemplary embodiment.

Referring to FIG. 14, the terminal device 900 may include a communication unit 910, an output unit 920, a storage unit 930, a control unit 940, and an input unit 950. The communication unit 910, the output unit 920, the storage unit 930, the control unit 940, and the input unit 950 of FIG. 14 have features similar to the communication unit 510, the output unit 520, the storage unit 530, the control unit 540, and the input unit 550 of FIG. 3, respectively, and thus redundant descriptions thereof are omitted.

Also, a webpage configuration requesting unit 941, a layout processing unit 942, a tile processing unit 943, and a view port detecting unit 944 of FIG. 14 have features similar to the webpage configuration requesting unit 741, the layout processing unit 742, the tile processing unit 743, and the view port detecting unit 744 of FIG. 8, respectively, and thus redundant descriptions thereof are omitted.

The control unit 940 may include the webpage configuration requesting unit 941, the layout processing unit 942, the tile processing unit 943, the view port detecting unit 944, and an input processing unit 945.

When the input processing unit 945 receives via the input unit 950 an input on a tile that is received from the cloud server 800 and is being displayed, the input processing unit 945 may generate input information and may request the cloud server 800 to transmit an event result caused in response to the input. For example, when the input via the input unit 950 is a touch input, the input processing unit 945 may transmit information about a touch type and coordinate information of the touch input to the cloud server 800. Also, the input processing unit 945 may further transmit view port information, which is detected by the view port detecting unit 944, to the cloud server 800 to provide the cloud server 800 with information about an area of the webpage being displayed on the terminal device 900.

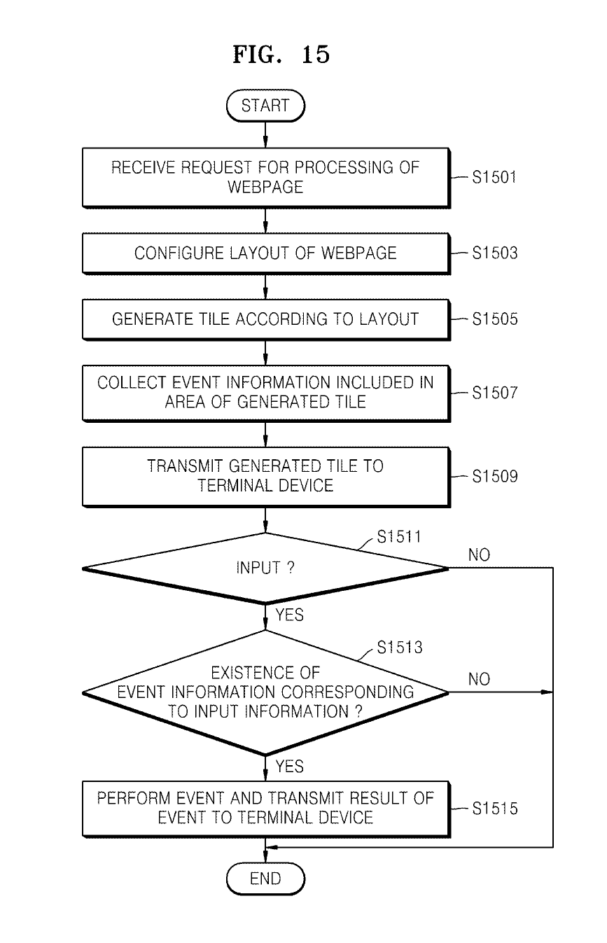

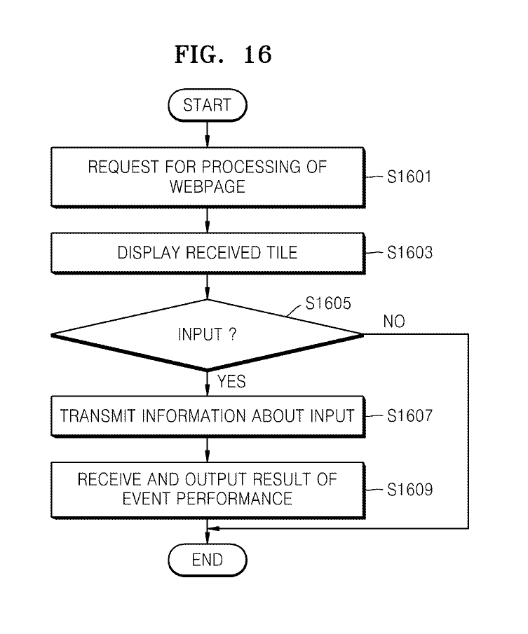

FIG. 15 is a flowchart of a method of processing, by the cloud server 800, a webpage when an input is performed on the webpage that is displayed on the terminal device 900, according to an exemplary embodiment.

Referring to FIG. 15, when the cloud server 800 receives a request for processing of the webpage from the terminal device 900 (operation S1501), the cloud server 800 may configure a layout of the webpage (operation S1503), generate tiles according to the configured layout (operation S1505), and transmit the tiles to the terminal device 900 (operation S1509).

Here, the cloud server 800 may collect event information using data related to the webpage, and the event information is about any events that may be triggered in a webpage area corresponding to the tiles by an external input on the webpage area (operation S1507).

When the cloud server 800 receives input information regarding an input received on one or more tiles being displayed on a screen of the terminal device, from the terminal device 900 (operation S1511), the cloud server 800 may determine if there is any event that should be triggered by the input matching the input information, using the event information that is collected in operation S1507 (operation S1513).

When any event information that corresponds to the input information exists, the cloud server 800 may perform the corresponding event according to the collected event information and may transmit a result of the event to the terminal device 900 (operation S1515).

FIG. 16 is a flowchart of a method of processing, by the terminal device 900, a webpage using the cloud server 800 when an input is received on the webpage that is being displayed on the terminal device 900, according to an exemplary embodiment.

The terminal device 900 may request the cloud server 800 to process the webpage (operation S1601) and, in response to the request, the terminal device 900 may receive and display one or more tiles (operation S1603). When the terminal device 900 receives an input via the input unit 950 (operation S1605), the terminal device 900 may transmit information about the input to the cloud server 800 (operation S1607), may receive a performance result of an event triggered by the input from the cloud server 800 and may output the performance result (operation S1609).

FIG. 17 is a block diagram illustrating a structure of a cloud server 1000 that provides a webpage to a terminal device 1100 by processing the webpage when data, which is not an image, i.e. non-image data, is included in the webpage, according to another exemplary embodiment.

Referring to FIG. 17, the cloud server 1000 may include a communication unit 1010, a layout configuration unit 1020, a tile generation unit 1030, a storage unit 1040, and a data processing unit 1050. The communication unit 1010, the layout configuration unit 1020, the tile generation unit 1030, and the storage unit 1040 of FIG. 17 have features similar to the communication unit 410, the layout configuration unit 420, the tile generation unit 430, and the storage unit 440 of FIG. 2, respectively, and thus redundant descriptions thereof are omitted.

In a case a webpage includes non-image data and one or more tiles corresponding to an webpage area, which includes an object visualizing the non-image data, is generated, the cloud server 1000 may transmit the tile, which is an image, to the terminal device 1100 and the data processing unit 1050 may control the cloud server 1000 to further process and separately transmit the non-image data to the terminal device 1100.

When the non-image data included in the webpage is, for example, music or a moving picture, the cloud server 1000 may process and transmit the non-image data in a streaming manner to the terminal device 1100, and when the non-image data is a text data, the cloud server 1000 may transmit text information and thus may allow the text to be output on the terminal device 1100.

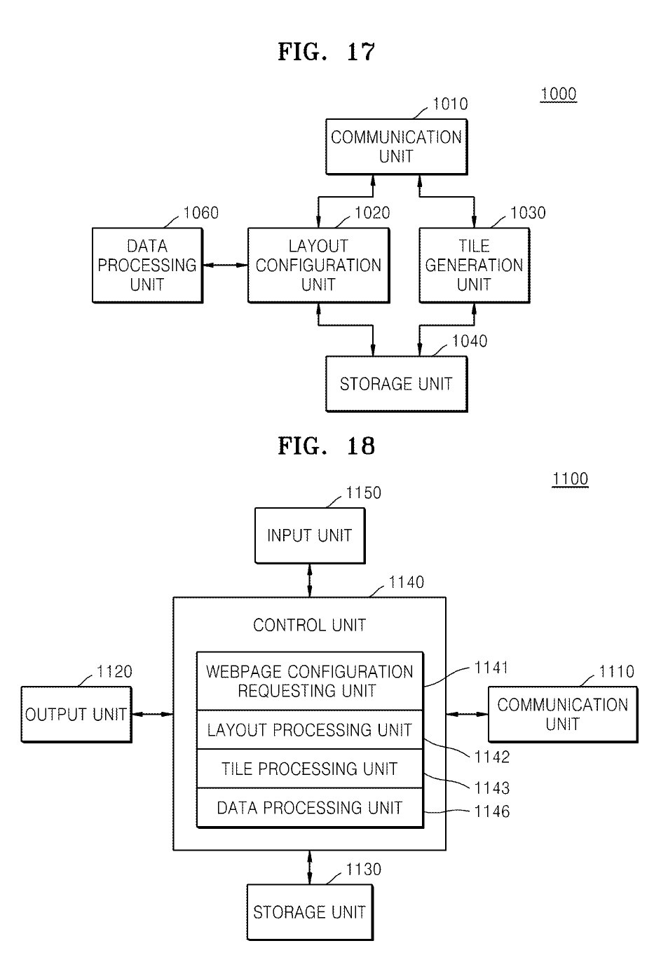

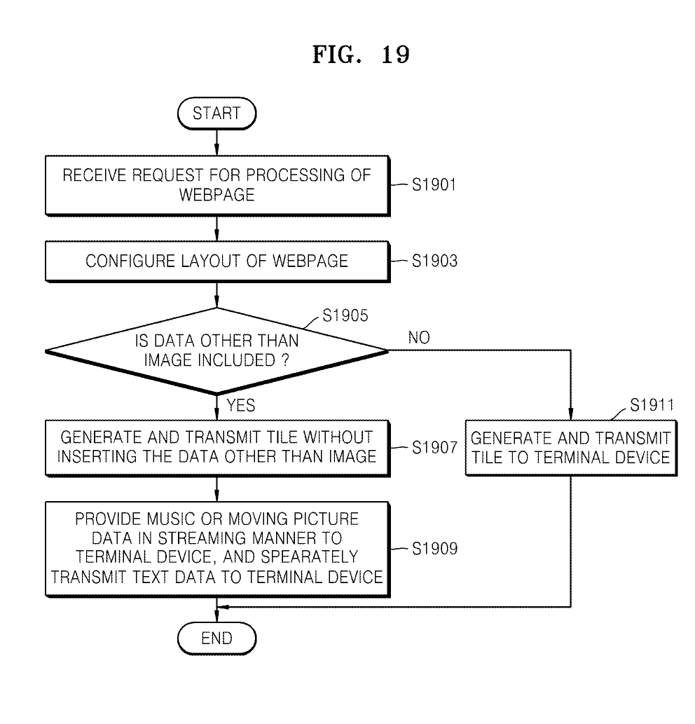

FIG. 18 is a block diagram illustrating a structure of the terminal device 1100 that processes a webpage using the cloud server 1000 and then outputs the webpage when non-image data is included in the webpage, according to another exemplary embodiment.

Referring to FIG. 18, the terminal device 1100 may include a communication unit 1110, an output unit 1120, a storage unit 1130, a control unit 1140, and an input unit 1150. The communication unit 1110, the output unit 1120, the storage unit 1130, the control unit 1140, and the input unit 1150 of FIG. 18 may have features similar to the communication unit 510, the output unit 520, the storage unit 530, the control unit 540, and the input unit 550 of FIG. 3, respectively, and thus redundant descriptions thereof are omitted.

Also, a webpage configuration requesting unit 1141, a layout processing unit 1142, and a tile processing unit 1143 of FIG. 18 have features similar to the webpage configuration requesting unit 541, the layout processing unit 542, and the tile processing unit 543 of FIG. 3, respectively, and thus redundant descriptions thereof are omitted.

The control unit 1140 may include the webpage configuration requesting unit 1141, the layout processing unit 1142, the tile processing unit 1143, and a data processing unit 1146.

When a tile of the webpage which is received from the cloud server 1000 includes non-image data, the data processing unit 1146 separately receives information about the non-image data from the cloud server 1000, and thus processes the non-image data to be output by the output unit 1120 of the terminal device 1100.

When the non-image data included in the webpage is, for example, music or a moving picture, the terminal device 1100 may receive and output the non-image data in a streaming manner from the cloud server 1000, and when the non-image data is a text, the terminal device 1100 may receive and output text information.

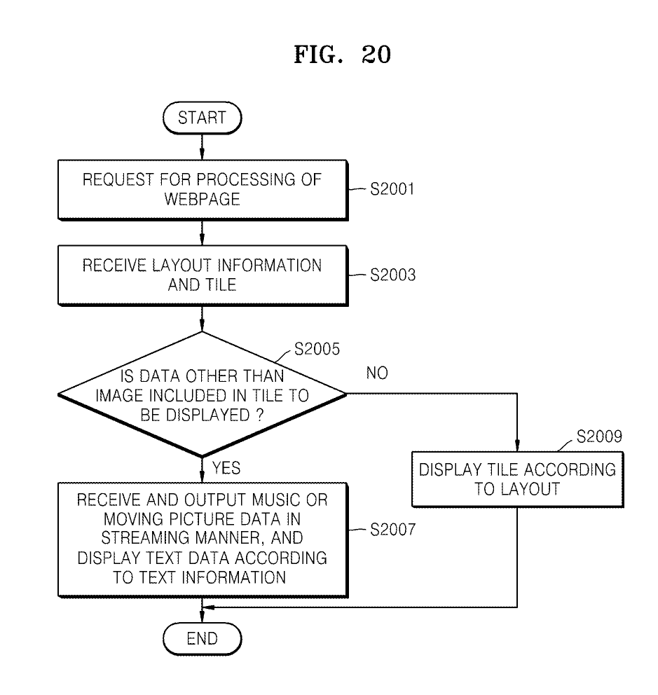

FIG. 19 is a flowchart of a method of processing, by the cloud server 1000, a webpage when non-image data is included in the webpage, according to an exemplary embodiment.

Referring to FIG. 19, when the cloud server 1000 receives a request for processing of a webpage from the terminal device 1100 (operation S1901), the cloud server 1000 may configure a layout of the webpage based on display information of the terminal device 1100 (operation S1903), generate tiles according to the configured layout and transmit the tiles to the terminal device 1100 (operation S1911).

In a case where the tile includes non-image data when the tile is generated (operation S1905), the cloud server 1000 may generate the tile using only an image without inserting the non-image data into the tile and may transmit the tile (operation S1907). Then, the cloud server 1000 may process and separately transmit the non-image data to the terminal device 1100. When the non-image data is music or moving picture data, the cloud server 1000 may provide the terminal device 1100 with the non-image data in a streaming manner, and when the non-image data is text data, the cloud server 1000 may transmit the text data to the terminal device 1100 (operation S1909).

FIG. 20 is a flowchart of a method of processing, by the terminal device 1100, a webpage using the cloud server 1000 and outputting the webpage when non-image data is included in the webpage, according to another exemplary embodiment.

Referring to FIG. 20, the terminal device 1100 may request the cloud server 1000 to process the webpage (operation S2001), may receive a tile in response to the request, and then may display the tile according to a layout (operations 52003 and S2009).

In a case in which the tile to be displayed includes the non-image data (operation S2005), when the non-image data is music or moving picture data, the terminal device 1100 may receive the non-image data in a streaming manner from the cloud server 1000 and may output the non-image data, and when the non-image data is text data, the terminal device 1100 may receive the text data from the cloud server 1000 and may output the text data (operation S2007).

The exemplary embodiments can be written as computer programs and can be implemented in general-use digital computers that execute the programs using a computer readable recording medium. In addition, a data structure used in the embodiments of the exemplary embodiments can be written in a computer readable recording medium through various means. Examples of the computer readable recording medium include magnetic storage media (e.g., ROM, floppy disks, hard disks, etc.), optical recording media (e.g., CD-ROMs, or DVDs), etc.

While this disclosure has been particularly shown and described with reference to exemplary embodiments thereof, it will be understood by those of ordinary skill in the art that various changes in form and details may be made therein without departing from the spirit and scope of the disclosure as defined by the appended claims. The exemplary embodiments should be considered in a descriptive sense only and not for purposes of limitation. Therefore, the scope of the disclosure is defined not by the detailed description but by the appended claims, and all differences within the scope will be construed as being included.

1. A method for a terminal device to process a webpage, the method comprising:
transmitting address information of a webpage and display information of a terminal device to a cloud server;
receiving layout information indicating a layout of the webpage and tiles of the webpage from the cloud server in response to the transmitting; and
displaying one or more of the tiles according to the layout information,
wherein the tiles of the webpage are obtained by dividing the webpage into a plurality of images based on the display information of the terminal device.

2. The method of claim 1, further comprising;
receiving a user input to change a view port of the webpage;
displaying a tile corresponding to a position and a size of the changed view port among the received tiles of the webpage;
transmitting information on the position and the size of the changed view port to the cloud server; and
receiving at least one tile of the webpage from the cloud server, wherein the at least one tile is determined by the cloud server based on the display information and on the changed view port.

3. The method of claim 1, further comprising;
receiving a user input on the webpage;
transmitting coordinate information of the user input on the webpage to the cloud server;
receiving a result of an event triggered by the input from the cloud server; and
outputting the result of the event.

4. The method of claim 1, wherein the displaying the one or more of the tiles comprises:
receiving data output information regarding non-image data included in a part of the webpage corresponding to the one or more of the tiles from the cloud server;
receiving the non-image data using address information of the non-image data included in the data output information;
processing the non-image data using the data output information;
combining the processed non-image data with the one or more of the tiles; and
outputting the one or more of the tiles combined with the non-image data.

5. A method for a cloud server to process a webpage, the method comprising:
receiving address information of a webpage and display information of a terminal device from the terminal device;
configuring a layout of the webpage corresponding to the address information based on the display information of the terminal device;
generating tiles of the webpage by dividing the webpage into a plurality of images according to the layout; and
transmitting one or more of the tiles and information on the layout to the terminal device.

6. The method of claim 5, further comprising:
receiving information on a position and a size of a changed view port from the terminal device;
generating new tiles by dividing the webpage into a plurality of images based on the information on the position and the size of the changed view port, according to the layout; and
transmitting one or more of the new tiles to the terminal device.

7. The method of claim 5, further comprising:
collecting event information on events that are triggered from the webpage by a user inputs on the terminal device;
receiving input information regarding a user input received on the webpage from the terminal device;
determining event information corresponding to the received input information;
performing an event based on the determined event information; and
transmitting a response message comprising a performance result of the event to the terminal device,
wherein the received input information comprises coordinate information of the input on the webpage.

8. The method of claim 5, wherein the generating tiles of the webpage comprises:
transmitting output information related to non-image data included in an area of the webpage corresponding to the tiles to the terminal device, wherein the output information includes at least one of information about a method of processing the non-image data, information on a location where the non-image data is to be received, and information on a position where the non-image data is visualized in the tiles.

9. The method of claim 5, further comprising:
determining that another set of layout information and tiles of the webpage generated based on display information identical to the display information of the terminal device are stored;
generating new tiles by dividing the webpage into a plurality of images using the stored layout information and the stored tiles when the layout information and the tiles of the webpage are stored; and
transmitting the new tiles to the terminal device.

10. A terminal device for processing a webpage, the terminal device comprising:
a communication unit configured to transmit and receive data via a network;
a control unit configured to transmit address information of a webpage and display information of the terminal device to a cloud server, to receive tiles and layout information of the webpage from the cloud server in response to the transmission, and to control one or more of the tiles to be displayed;
an output unit configured to display the one or more of the tiles of the webpage according to control by the control unit; and
a storage unit configured to store the tiles of the webpage received from the cloud server,
wherein the tiles of the webpage are obtained by dividing the webpage into the plurality of images based on the display information of the terminal device.

11. The terminal device of claim 10, wherein the control unit comprises:
a webpage configuration requesting unit configured to transmit the address information of the webpage and the display information of the terminal device to the cloud server;
a layout processing unit configured to control the one or more of the tiles of the webpage to be displayed according to the layout information; and
a tile processing unit configured to determine the one or more of the tiles to be displayed among the plurality of tiles of the webpage according to predetermined setting information.

12. The terminal device of claim 11, the control unit further comprising a view port detecting unit configured to, when the view port of the webpage is changed, detect information on a position and a size of a changed view port and to transmit the information to the cloud server,
wherein the tile processing unit controls the output unit to display a tile corresponding to the position and the size of the changed view port and receives at least one tile of the webpage from the cloud server, and
wherein the at least one tile is determined by the cloud server based on the display information and the information on a position and a size of the changed view port.

13. The terminal device of claim 11, further comprising,
an input unit configured to receive a user input on the webpage, and
the control unit further comprising an input processing unit configured to transmit coordinate information of the user input to the cloud server, to receive a result of an event triggered by the input from the cloud server, and to output the result of the event.

14. The terminal device of claim 11, the control unit further comprising a data processing unit configured to receive data output information regarding non-image data included in a part of the webpage corresponding to the one or more of the tiles, receive the non-image data using address information included in data output information, to process the non-image data using the data output information, to combine the processed non-image data with the one or more of the tiles, and to output the one or more of the tiles combined with the non-image data.

15. A cloud server for processing a webpage, the cloud server comprising:
a communication unit configured to transmit and receive data via a network;
a layout configuration unit configured to configure a layout of a webpage; and
a tile generation unit configured to generate tiles of the webpage to be output on a terminal device by dividing the webpage into a plurality of images based on display information of the terminal device according to the layout.

16. The method claim of 2, wherein the at least one tile includes a predetermined number of tiles that are adjacent to the tile corresponding to the position and the size of the changed view port.
